(19) United States
(12) Patent Application Publication
(10) Pub. No.: US 2018/0359949 A1
(43) Pub. Date: Dec. 20, 2018

(54) SYSTEMS AND METHODS FOR UTILIZING PRESSURE RECIPES FOR A GROW POD

(71) Applicant: Grow Solutions Tech LLC, Lehi, UT (US)

(72) Inventors: Gary Bret Millar, Highland, UT (US); Michael Stephen Hurst, Farmington, UT (US)

(21) Appl. No.: 15/992,283

(22) Filed: May 30, 2018

Related U.S. Application Data
(60) Provisional application No. 62/519,304, filed on Jun. 14, 2017.
(60) Provisional application No. 62/519,655, filed on Jun. 14, 2017.

(51) Int. Cl. A01G 9/24; A01G 7/00; A01G 9/20

(52) U.S. Cl. CPC A01G 9/24; A01G 31/042; A01G 9/20; A01G 7/00

(57) ABSTRACT

A pressure control system includes a sealed area containing one or more carts for growing plant material, the one or more carts movably supported on a track within the sealed area, an air pressure controller operably coupled to the sealed area such that the air pressure controller controls an air pressure within the sealed area, and a controller. The controller includes a processor, a data storage device storing one or more pressure recipes, and a non-transitory, processor-readable storage medium comprising one or more programming instructions stored thereon. The one or more programming instructions, when executed by the processor, cause the processor to: identify the plant material in the one or more carts, retrieve a pressure recipe for the identified plant material from the data storage device, and direct the air pressure controller to adjust the air pressure within the sealed area based on the pressure recipe for the identified plant material.

### CROSS REFERENCE TO RELATED APPLICATIONS

This application claims the benefit of U.S. Provisional Application No. 62/519,304, filed Jun. 14, 2017, and the benefit of U.S. Provisional Application No. 62/519,655, filed Jun. 14, 2017, the contents of which are hereby incorporated by reference in their respective entireties.

### TECHNICAL FIELD

Embodiments described herein generally relate to systems and methods for utilizing pressure recipes for a grow pod and, more specifically, to controlling an air pressure within an enclosure of a grow pod based on pressure recipes for seeds, seedlings, and/or plants being grown in the grow pod.

### BACKGROUND

While crop growth technologies have advanced over the years, there are still many problems in the farming and crop industry today. As an example, while technological advances have increased efficiency and production of various crops, many factors may affect a harvest, such as weather, disease, infestation, and the like. Additionally, while the some countries currently have suitable farmland to adequately provide food for their population, other countries and future populations may not have enough farmland to provide the appropriate amount of food. Artificial environments having artificially generated climates may be used to grow crops indoors. However, various types of plants grow and thrive in specific climates having one or more specific air pressures. As such, there is a need for the organized plant grow pod system to provide controlled and optimal environmental conditions (e.g., the timing and wavelength of light, pressure, temperature, watering, nutrients, molecular atmosphere, and/or other variables) in order to maximize plant growth and output.

### SUMMARY

In one embodiment, a pressure control system includes a sealed area containing one or more carts for growing plant material, the one or more carts movably supported on a track within the sealed area, an air pressure controller operably coupled to the sealed area such that the air pressure controller controls an air pressure within the sealed area, and a controller. The controller includes a processor, a data storage device storing one or more pressure recipes, and a non-transitory, processor-readable storage medium comprising one or more programming instructions stored thereon. The one or more programming instructions, when executed by the processor, cause the processor to: identify the plant material in the one or more carts, retrieve a pressure recipe for the identified plant material from the data storage device, and direct the air pressure controller to adjust the air pressure within the sealed area based on the pressure recipe for the identified plant material.

In another embodiment, a method for controlling an air pressure within an assembly line grow pod includes identifying, by a grow pod computing device, plant material in one or more carts, where the one or more carts are disposed in a sealed area of the assembly line grow pod, the sealed area having the air pressure controlled by an air pressure controller. The method further includes retrieving, by the grow pod computing device, a pressure recipe corresponding to the identified plant material from a data storage device and directing, by the grow pod computing device, the air pressure controller to adjust the air pressure within the sealed area based on the pressure recipe for the identified plant material.

In another embodiment, an assembly line grow pod includes an enclosure having an inner wall and an outer wall encompassing the inner wall. A first sealed area is defined within the inner wall and a second sealed area is defined between the inner wall and the outer wall. A cart is supported on a track within the first sealed area, an air pressure controller is fluidly coupled to the first sealed area and the second sealed area, and a controller communicatively coupled to the air pressure controller, the controller providing signals to the air pressure controller to adjust an air pressure within the first sealed area and the second sealed area.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts an illustrative assembly line grow pod according to one or more embodiments shown and described herein;

FIG. 2A schematically depicts a first view of illustrative components within an assembly line grow pod according to one or more embodiments shown and described herein;

FIG. 2B schematically depicts a second view of illustrative components within the assembly line grow pod according to one or more embodiments shown and described herein;

FIG. 3 schematically depicts a cross-section of an illustrative enclosure for an assembly line grow pod and a block diagram of illustrative control components according to embodiments described herein.

FIG. 4A depicts an illustrative graphical user interface for selecting a type of plant material according to one or more embodiments shown and described herein;

FIG. 4B depicts an illustrative graphical user interface for selecting a simulated altitude for growing a plant material according to one or more embodiments shown and described herein;

FIG. 4C depicts an illustrative graphical user interface for selecting a region for growing a plant material according to one or more embodiments shown and described herein;

FIG. 5 depicts a flow chart of an illustrative method for controlling the air pressure inside the enclosure based on a pressure recipe according to one or more embodiments shown and described herein;

FIG. 6 depicts another flow chart of an illustrative method for controlling the air pressure inside the enclosure based on a pressure recipe, according to one or more embodiments shown and described herein; and

FIG. 7 depicts a flow chart for an illustrative method of identifying, retrieving, defining, and implementing a pressure recipe, according to one or more embodiments shown and described herein.

### DETAILED DESCRIPTION

Embodiments disclosed herein include systems and methods for utilizing pressure recipes for growing plants, seeds, and/or seedlings in an assembly line grow pod. Some embodiments are configured with a pressure control system that includes an enclosure for enclosing a grow pod, an air pressure controller, and a master controller. The enclosure may include an outer wall and an inner wall. The master controller identifies plant material (e.g., plants, seeds, and/or seedlings) being grown in the grow pod, and instructs the air pressure controller to control an air pressure of a sealed area inside the inner wall based on the pressure recipes for the plant material. The systems and methods for utilizing pressure recipes for a grow pod will be described in more detail, below.

As used herein, “plant material” refers to the one or more plants, seeds, and/or seedlings held by a cart for growing. Additionally, “plant material” may further refer to the products, flowers, fruits, and/or the like produced from the plants, seeds, and/or seedlings.

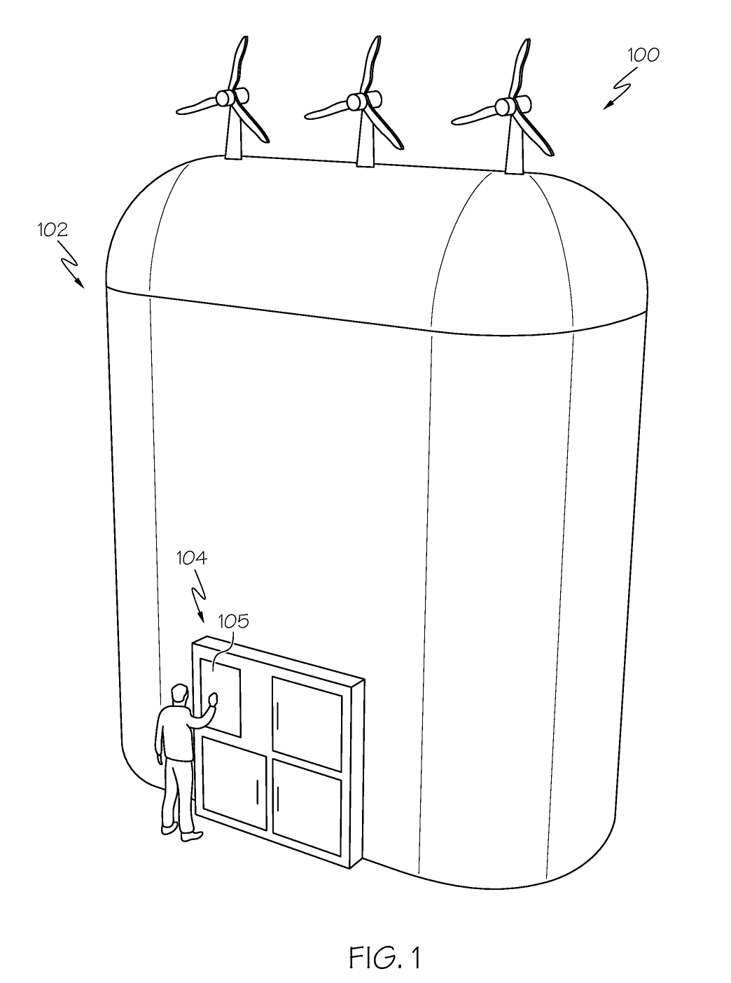

Referring now to the drawings, FIG. 1 depicts an assembly line grow pod 100 according to one or more embodiments shown and described herein. As illustrated, the assembly line grow pod 100 includes an enclosure 102. The assembly line grow pod 100 may be a self-contained unit that maintains an environment inside the enclosure 102 and shields the interior of the assembly line grow pod 100 from external environmental conditions. Depending on the embodiment, the enclosure 102 may provide a pressurized environment to prevent (or at least reduce) insects, mold, other organisms, contaminants, particulate matter, and/or the like from entering the enclosure 102. The enclosure 102 may also maintain the assembly line grow pod at a certain air pressure level, as described in more detail herein.

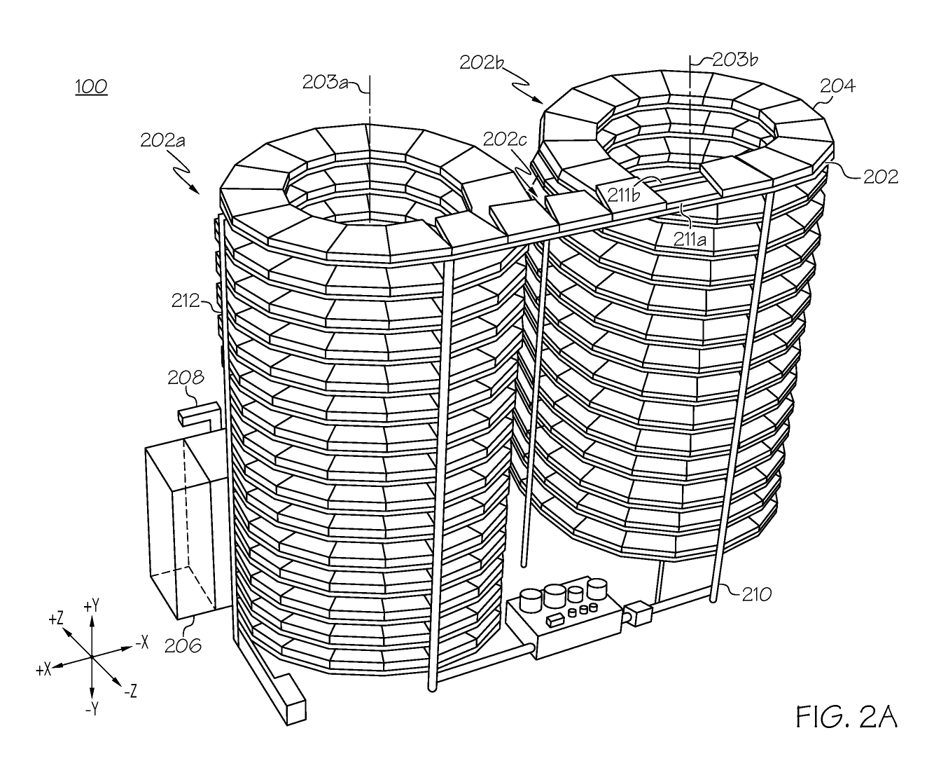

The surface of the enclosure 102 may be smooth or corrugated. The enclosure 102 may be made from air proof material, such as concrete, steel, plastic, or the like. As shown in FIG. 1, the enclosure 102 has curved corners which may be suitable and customized to enclose the assembly line grow pod 100 as illustrated in FIGS. 2A and 2B. The curved corners of the enclosure may provide increased stability during adverse weather conditions such as high winds or the like. Additionally, a curved roof structure may prevent debris, rain, snow, or other material from collecting on the roof of the enclosure. However, the shape of the enclosure 102 depicted in FIG. 1 is only one example. Other shapes and configurations are also contemplated to be within the scope of the present disclosure.

In some embodiments, coupled to the enclosure 102 is a display 104 (e.g., a control panel) optionally incorporating an input device 105 such as a touch input, keyboard, mouse, or the like. A user may access the master controller through the display 104 (e.g., the control panel) to adjust settings, provide an input, and monitor the conditions, such as pressure level and other environmental conditions within the enclosure 102. For example, the display 104 on the exterior of the enclosure 102 of the assembly line grow pod 100 may indicate a status of the assembly line grow pod 100, allow a user to configure the operation of the assembly line grow pod 100, and/or the like. A user may further utilize the display 104 and the input device 105 to input information relating to a type of plant material, a simulated altitude at which the plant material is to be grown, a simulated geographical region at which the plant material is to be grown, and/or the like, as described in greater detail herein.

Referring now to FIGS. 2A and 2B, various interior components of the assembly line grow pod 100 are depicted. The various components of the assembly line grow pod 100 may be arranged within the enclosure 102. As illustrated, the assembly line grow pod 100 may include a track 202 that holds one or more carts 204. The track 202 may include an ascending portion 202a, a descending portion 202b, a first connection portion 202c, and a second connection portion 202d (FIG. 2B). The track 202 may wrap around (e.g., in a counterclockwise direction in FIGS. 2A and 2B, although clockwise or other configurations are also contemplated) a first axis 203a such that the carts 204 ascend upward in a vertical direction (e.g., in the +Y direction of the coordinate axes of FIG. 2A). The first connection portion 202c may be relatively level (although this is not a requirement) and may be utilized to transfer carts 204 to the descending portion 202b. The descending portion 202b may be wrapped around a second axis 203b (e.g., in a counterclockwise direction in FIGS. 2A and 2B) that is substantially parallel to the first axis 203a, such that the carts 204 may be returned closer to ground level (e.g., towards the −Y direction of the coordinate axes of FIG. 2A).

In some embodiments, a second connection portion 202d (shown in FIG. 2B) may be positioned near ground level that couples the descending portion 202b to the ascending portion 202a such that the carts 204 may be transferred from the descending portion 202b to the ascending portion 202a. Similarly, some embodiments may include more than two connection portions to allow different carts 204 to travel different paths. As an example, some carts 204 may continue traveling up the ascending portion 202a, while some may take one of the connection portions before reaching the top of the assembly line grow pod 100.

Also depicted in FIG. 2A is a master controller 206. The master controller 206 may include an input device, an output device and/or other components. The master controller 206 may be communicatively coupled to a nutrient dosing component, a water distribution component, a seeder component 208, and/or other hardware for controlling the various components of the assembly line grow pod 100.

The seeder component 208 may be configured to provide seeds to one or more carts 204 as the carts 204 pass the seeder in the assembly line. Depending on the particular embodiment, each cart 204 may include a tray 230 (FIG. 2B) for receiving a plurality of seeds. In some embodiments, the tray 230 may be a multiple section tray for receiving individual seeds in each section (or cell) or receiving a plurality of seeds in each cell. The seeder component 208 may detect a presence of the respective cart 204 and may begin laying seed across an area of the cells within the tray 230. The seed may be laid out according to a desired depth of seed, a desired number of seeds, a desired surface area of seeds, and/or according to other criteria. In some embodiments, the seeds may be pre-treated with nutrients and/or anti-buoyancy agents (such as water) as these embodiments may not utilize soil to grow the seeds and thus might need to be submerged.

The watering component may be coupled to one or more water lines 210, which distribute water and/or nutrients to one or more trays 230 (FIG. 2B) at predetermined areas of the assembly line grow pod 100. In some embodiments, seeds may be sprayed to reduce buoyancy and then watered. Additionally, water usage and consumption may be monitored, such that at subsequent watering stations, this data may be utilized to determine an amount of water to apply to a seed at that time.

Also depicted in FIG. 2A are airflow lines 212. Specifically, the master controller 206 may include and/or be coupled to one or more components that delivers airflow for temperature control, pressure, carbon dioxide control, oxygen control, nitrogen control, and/or the like. Accordingly, the airflow lines 212 may distribute the airflow at predetermined areas in the assembly line grow pod 100. The airflow lines 212 may further be fluidly coupled to an air pressure controller for delivering or removing air from the interior of the assembly line grow pod 100, as described in greater detail herein.

Referring now to FIG. 2B, a second view of the assembly line grow pod 100 illustrating a plurality of components of an assembly line grow pod 100 is depicted. As illustrated, the seeder component 208 is illustrated, as well as lighting devices 216, a harvester component 218, and a sanitizer component 220.

The assembly line grow pod 100 may include a plurality of lighting devices 216 such as light emitting diodes (LEDs). While in some embodiments LEDs may be utilized for this purpose, this is not a requirement. The lighting devices 216 may be disposed on the track 202 opposite the carts 204, such that the lighting devices 216 direct light waves to the carts 204 on the portion the track 202 directly below. In some embodiments, the lighting devices 216 are configured to create a plurality of different colors and/or wavelengths of light, depending on the application, the type of plant being grown, and/or other factors. The lighting devices 216 may provide light waves that may facilitate plant growth. Depending on the particular embodiment, the lighting devices 216 may be stationary and/or movable. As an example, some embodiments may alter the position of the lighting devices 216, based on the plant type, stage of development, recipe, and/or other factors.

Additionally, as the plants are provided with light, water, and nutrients, the carts 204 traverse the track 202 of the assembly line grow pod 100. Additionally, the assembly line grow pod 100 may detect a growth and/or fruit output of a plant and may determine when harvesting is warranted. If harvesting is warranted prior to the cart 204 reaching the harvester, modifications to a recipe may be made for that particular cart 204 until the cart 204 reaches the harvester. Conversely, if a cart 204 reaches the harvester component 218 and it has been determined that the plants in that cart 204 are not ready for harvesting, the assembly line grow pod 100 may commission that cart 204 for another cycle. This additional cycle may include a different dosing of light, water, nutrients, and/or other treatment and the speed of the cart 204 could change, based on the development of the plants on the cart 204. If it is determined that the plants on a cart 204 are ready for harvesting, the harvester component 218 may facilitate that process.

Still referring to FIG. 2B, the sanitizer component 220 may clean the cart 204 and/or tray 230 and return the tray 230 to a growing position. The tray 230, the cart 204, both, or neither may be overturned for cleaning. In any event, the tray 230 and/or cart 204 are returned to a growing position such that they may traverse the track 202 and receive and grow plants therein. As illustrated, the sanitizer component 220 may return the tray 230 to the growing position, which is substantially parallel to ground. Additionally, a seeder head 214 may facilitate seeding of the tray 230 as the cart 204 passes. It should be understood that while the seeder head 214 is depicted in FIG. 2B as an arm that spreads a layer of seed across a width of the tray 230, this is merely an example. Some embodiments may be configured with a seeder head 214 that is capable of placing individual seeds in a desired location.

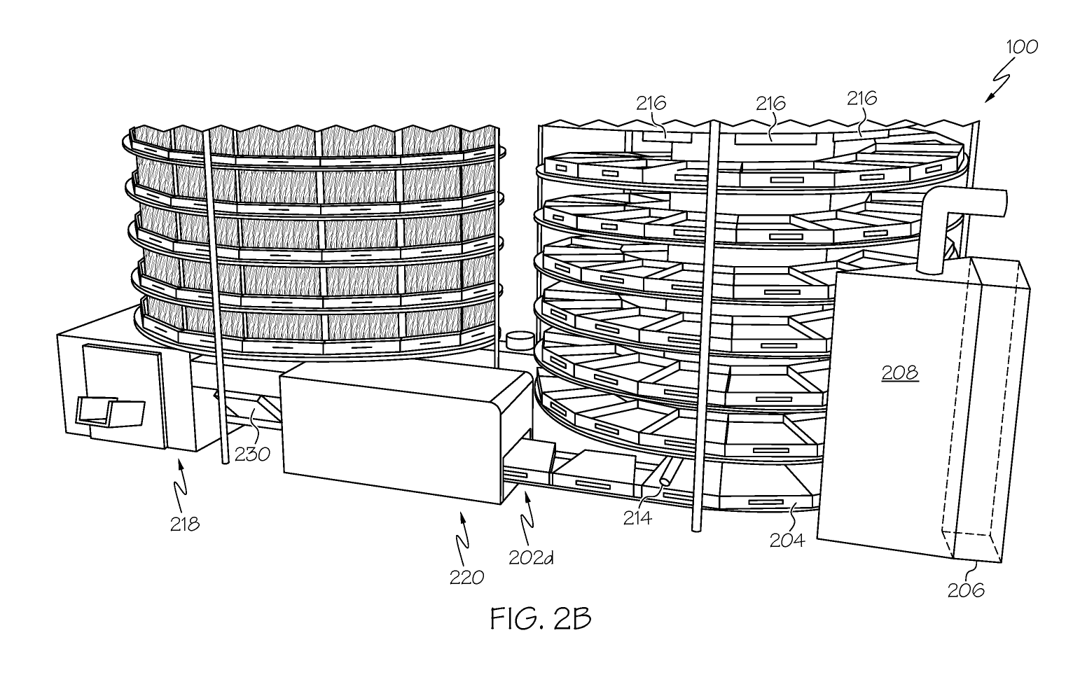

FIG. 3 depicts a cross-section of the enclosure 102 of the assembly line grow pod 100, according to one or more embodiments shown and described herein. The enclosure 102 may include a plurality of walls, such as an inner wall 330 and an outer wall 320 encompassing the inner wall 330. The outer wall 320 and the inner wall 330 may be made of any material that prevents air passing through the wall, such as concrete, steel, plastic, and/or the like. The outer wall 320 generally defines a barrier between an exterior environment 340 outside the assembly line grow pod 100 and an interior environment 300 containing the various interior components of the assembly line grow pod 100. The inner wall 330 generally defines a first sealed area 344 within the interior environment 300 of the assembly line grow pod 100. In addition, the outer wall 320 and the inner wall 330 define a second sealed area 342 located between the first sealed area 344 and the exterior environment 340. As such, the second sealed area 342 is sealed by the outer wall 320 and the inner wall 330 and the first sealed area 344 is sealed by the inner wall 330. In order to prevent (or at least reduce) the presence of insects, mold, other organisms, particulate matter, contaminants, and/or the like from entering the interior environment 300, the second sealed area 342 may be maintained at a pressure that is higher than that of the exterior environment 340, which may be referred to as a positive pressure area. In addition, the first sealed area 344 may be maintained at a particular pressure that is suitable for plant matter growth and/or according to a particular recipe, as described in greater detail herein. While FIG. 3 depicts the enclosure 102 as having two walls, it should be understood that the enclosure 102 may include more than two walls or a single wall without departing from the scope of the present disclosure. Furthermore, while the walls depicted in FIG. 3 are single layered walls (for example, walls having a single layer of material), this is merely illustrative. In some embodiments, each of the walls may be constructed as multiple layered walls (for example, walls having a plurality of layers of material) without departing from the scope of the present disclosure.

In embodiments, the assembly line grow pod 100 may have an air pressure controller 310. The air pressure controller 310 may be communicatively coupled to the master controller 206 such that the master controller may send commands and receive signals from the air pressure controller 310 and components such as air pressure gauges 312 and 314 operably coupled thereto. In some embodiments, the air pressure controller 310 may be communicatively coupled directly with the master controller 206, while in others communication may occur through a network 350. The air pressure controller 310 is generally a device fluidly coupled to the interior environment 300 and configured to control the air pressure in the second sealed area 342 and the air pressure in the first sealed area 344. The air pressure controller 310 may be a part of an HVAC system for the assembly line grow pod 100, which controls temperature, airflow, and/or the like. In some embodiments, the air pressure controller 310 may be a separate device from the HVAC system. The air pressure controller 310 includes a first air channel 316 and a second air channel 318. The first air channel 316 may be fluidly coupled to the second sealed area 342. The second air channel 318 may be fluidly coupled or exposed to the first sealed area 344.

In some embodiments, the air pressure controller 310 may include an air pressure decreasing device 315, such as a vacuum pump or the like that applies a vacuum. For example, the air pressure decreasing device 315 applies a vacuum to the first sealed area 344 through the second air channel 318 such that the air pressure of the first sealed area 344 is decreased. As another example, the air pressure decreasing device 315 applies a vacuum to the second sealed area 342 through the first air channel 316 such that the air pressure of the second sealed area 342 is decreased.

In some embodiments, the air pressure controller 310 may also include an air pressure increasing device 317, such as a compressor or the like that outputs compressed air. For example, the air pressure increasing device 317 outputs compressed air through the first air channel 316 into the second sealed area 342, such that the air pressure in the second sealed area 342 is increased. As another example, the air pressure increasing device 317 outputs compressed air through the second air channel 318 into the first sealed area 344, such that the air pressure in the first sealed area 344 is increased. In this regard, the air pressure controller 310 may control the air pressure of the second sealed area 342 and the first sealed area 344, independently. In some embodiments, the first air channel 316 and the second air channel 318 are connected within the air pressure controller 310 such that the air pressure controller 310 pulls air from the first sealed area 344 and outputs the pulled air into the second sealed area 342.

In some embodiments, the air pressure controller is fluidly coupled to the exterior environment 340 through a third air channel 319. The third air channel may include a filter or the like to prevent contaminants, particulate matter, or the like from entering the interior environment 300 (e.g., the first sealed area 344 and the second sealed area 342). The air pressure controller 310 may utilize the third air channel 319 to pump air from the exterior environment 340 into the interior environment when increasing the air pressure of the first sealed area 344 and/or the second sealed area 342. Additionally, the air pressure controller 310 may utilize the third air channel 319 to release or pump air from the first sealed area 344 and/or the second sealed area 342.

In some embodiments, a first air pressure gauge 312 may be attached to the first air channel 316. The first air pressure gauge 312 measures the air pressure of the second sealed area 342. In some embodiments, a second air pressure gauge 314 may be attached to the second air channel 318. The second air pressure gauge 314 measures the air pressure of the first sealed area 344. The first air pressure gauge 312, the second air pressure gauge 314, and the air pressure controller 310 may each be communicatively coupled to the master controller 206. For example, the first air pressure gauge 312 may transmit one or more signals corresponding to the air pressure of the second sealed area 342 to the master controller 206 via a wired or a wireless communication. Similarly, the second air pressure gauge 314 may transmit one or more signals corresponding to the air pressure of the first sealed area 344 to the master controller 206 via a wired or a wireless communication. The master controller 206 may control the operation of the air pressure controller 310, for example, by sending an instruction to increase or decrease the air pressure in the second sealed area 342 and/or the first sealed area 344.

The master controller 206 may include a computing device 332. The computing device 332 may include a processor 338, a data storage device 337, and a non-transitory, processor-readable storage medium 334 (e.g., also referred to as a memory component or memory module). The non-transitory, processor-readable storage medium 334 generally stores one or more programming instructions thereon that, when executed, cause the processor 338 to execute one or more programming steps, as described in greater detail herein. The one or more programming steps may be embodied within system logic 335 and/or plant logic 336 in the non-transitory, processor-readable storage medium 334.

In some embodiments, the data storage device 337 may be included within the master controller 206, while in other embodiments, the data storage device 337 may be a remote device that is communicatively coupled to the master controller 206.

The computing device 332, particularly the processor 338 thereof, may be any device capable of executing the programming instructions stored in the non-transitory, processor-readable storage medium 334. Accordingly, the processor 338 may be an electric controller, an integrated circuit, a microchip, a computer, or any other computing device.

The computing device 332 may be communicatively coupled to the other components of the assembly line grow pod 100 by a communication path. Accordingly, the communication path may communicatively couple any number of processors with one another, and allow the components coupled to the communication path to operate in a distributed computing environment. Specifically, each of the components may operate as a node that may send and/or receive data. Embodiments may include a single computing device or may include more than one computing device, for example and without limitation, user computing device 352 and/or remote computing device 354.

The non-transitory, processor-readable storage medium 334 may be communicatively coupled to or included within the computing device 332. The non-transitory, processor-readable storage medium 334 may comprise RAM, ROM, flash memories, hard drives, or any non-transitory computer readable memory device capable of storing programming instructions such that the programming instructions can be accessed and executed by the computing device 332. The programming instructions (e.g., first logic) may comprise logic or algorithm(s) written in any programming language of any generation (e.g., 1GL, 2GL, 3GL, 4GL, or 5GL) such as, for example, machine language that may be directly executed by the computing device 332, or assembly language, object-oriented programming (OOP), scripting languages, microcode, and/or the like, that may be compiled or assembled into machine-readable instructions and stored in the non-transitory, processor-readable storage medium 334. Alternatively, the programming instructions may be written in a hardware description language (HDL) such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. Embodiments may include a single non-transitory, processor-readable storage medium or may include more than one non-transitory, processor-readable storage medium.

As mentioned herein, one or more programming instructions may be embodied within the system logic 335 and/or the plant logic 336 in the non-transitory, processor-readable storage medium 334. For example, the system logic 335 may monitor and control operations of one or more of the components of the assembly line grow pod 100. That is, the system logic 335 may monitor and control operations of the air pressure controller 310. The system logic 335 compares the air pressure of the exterior environment 340 with the air pressure of the second sealed area 342, and instructs the air pressure controller 310 to increase the pressure of the second sealed area 342 if the air pressure of the second sealed area 342 is not greater than the air pressure of the exterior environment 340 by at least a certain amount. That is, the second sealed area 342 may maintain a positive pressure with respect to the exterior environment 340. This threshold amount may be predetermined and established based on historical data, plant growth patterns, damage by insects, mold, or any other external factors, or the like. Thus, a predetermined pressure gap to be maintained may be stored in the master controller 206 such that the master controller 206 controls the operation of the air pressure controller 310 to maintain the predetermined pressure gap.

The plant logic 336 may be configured to determine and/or receive a pressure recipe for plant growth and may facilitate implementation of the pressure recipe via the system logic 335. For example, a pressure recipe for a plant determined by the plant logic 336 includes a predetermined air pressure value, and the system logic 335 may instruct the air pressure controller 310 to adjust the air pressure of the first sealed area 344 based on the predetermined air pressure value. In some embodiments, the pressure recipe may be a part of a grow recipe. The grow recipe for plant growth may dictate the timing and wavelength of light, pressure, temperature, watering, nutrients, molecular atmosphere, and/or other variables the optimize plant growth and output.

The data storage device 337 may be a device similar to the non-transitory, processor-readable storage medium 334. That is, the data storage device 337 may comprise RAM, ROM, flash memories, hard drives, or any non-transitory computer readable memory device capable of storing programming instructions such that the programming instructions can be accessed and executed by the computing device 332. The data storage device 337 may store the pressure recipes such that the master controller 206 may access and extract the pressure recipes. Embodiments may include a single data storage device or more than one data storage device.

Additionally, the master controller 206 is communicatively coupled to a network 350. The network 350 may include the internet or other wide area network, a local network, such as a local area network, a near field network, such as Bluetooth or a near field communication (NFC) network. The network 350 is also communicatively coupled to a user computing device 352, a remote computing device 354, and/or the air pressure controller 310. In some embodiments, the network may also communicatively couple to the display 104 and the input device 105. The user computing device 352 may be a personal computer, laptop, mobile device, tablet, server, or the like and may be utilized as an interface with a user. As an example, a user may send a pressure recipe to the master controller 206 for implementation by the assembly line grow pod 100. Another example may include the master controller 206 sending notifications to a user of the user computing device 352.

Similarly, the remote computing device 354 may be a server, personal computer, tablet, mobile device, and/or the like and may be utilized for machine-to-machine communications. As an example, if the master controller 206 determines a type of plant and/or seed being used (and/or other information, such as ambient conditions), the master controller 206 may communicate with the remote computing device 354 to retrieve a previously stored grow recipe or pressure recipe for those conditions. As such, some embodiments may utilize an application program interface (API) to facilitate this or other computer-to-computer communications.

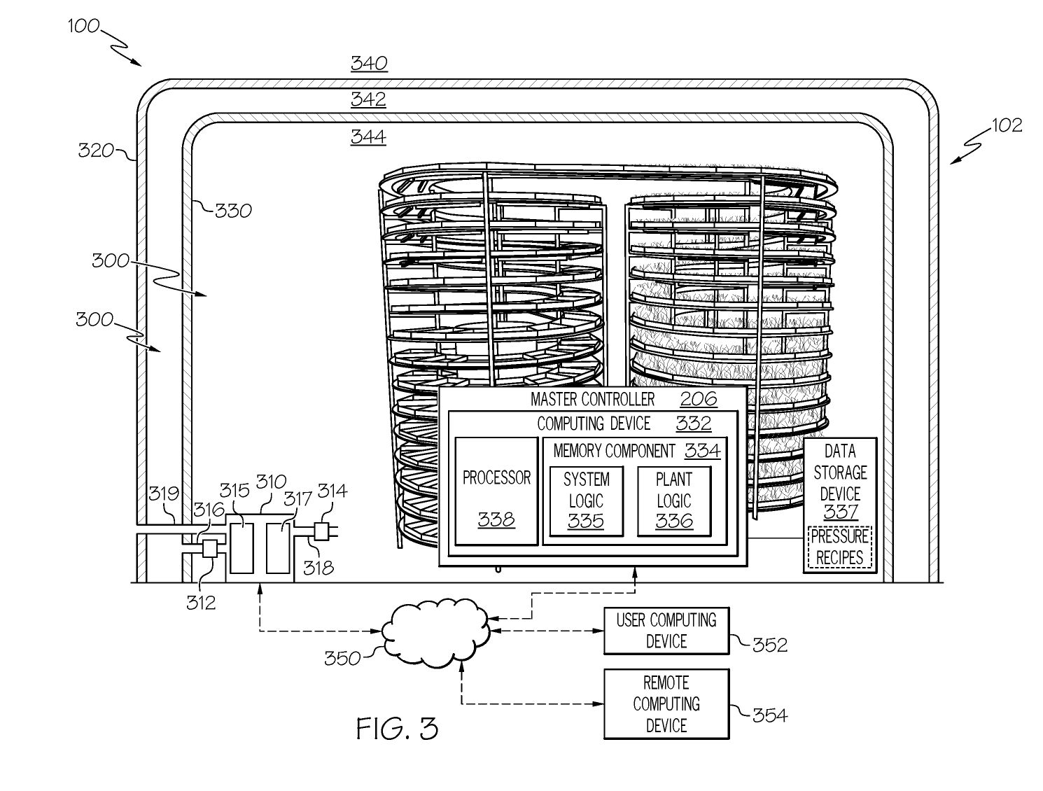

FIGS. 4A through 4C depict various user interfaces that are used to receive user inputs, which can then be used to determine and/or generate a pressure recipe for plant material according to embodiments described herein. Referring now to FIGS. 1, 3, and 4A, a graphical user interface 410 provided on a display (for example, the display 104 and/or a display of the user computing device 352) shows options for selecting a type of plant. A user may select a type of plant for seeding in the assembly line grow pod 100 from a selectable list of one or more types of plants presented on the display or by other means. For example, if the user selects plant A, the display 104 and/or user computing device 352 transmits instructions to the master controller 206 to direct the seeder 108 to provide seed corresponding to plant A in one or more trays 230. In some embodiments, the graphical user interface 410 may also provide the user with the ability to program a pressure recipe to store in one or more non-transitory, processor-readable storage mediums 334 or the data storage device 337 and/or implement by way of the master controller 206. By selecting a type of plant, the master controller 206 may retrieve a pressure recipe from the one or more non-transitory, processor-readable storage mediums 334 and/or create a new pressure recipe by querying the user for more information. For example, the master controller 206 may direct the display 104 to display an interface used to query the user regarding one or more simulated altitudes, one or more simulated geographical regions, and/or one or more air pressures to associate with the selected type of plant material.

FIG. 4B depicts one embodiment after one of the plants in FIG. 4A is selected. Referring to FIGS. 1, 3, and 4B, the graphical user interface 410 shows plant A being selected, and options 420 for selecting a simulated altitude for plant A. The options may include different simulated altitudes, for example, 0 feet (e.g., sea level), 1,000 feet above sea level, 2,000 feet above sea level, 3,000 feet above sea level, 4,000 feet above sea level, 5,000 feet above sea level, 6,000 feet above sea level, 10,000 feet above sea level, 15,000 feet above sea level, 20,000 feet above sea level, 30,000 feet above sea level, or any value there between. The user may select one of the simulated altitudes for growing plant A. If 1,000 feet is selected, the display 104 and/or user computing device 352 transmits the selected simulated altitude to the master controller 206, and the master controller 206 determines an air pressure based on the selected simulated altitude, e.g., 97.7 kPa. The master controller 206 may then store the selected type of plant and the selected simulated altitude as a pressure recipe in the one or more non-transitory, processor-readable storage mediums 334. In some embodiments, the master controller 206 instructs the air pressure controller 310 to set the air pressure of the first sealed area 344 to be 97.7 kPa. This is only one example. In some embodiments, the graphical user interface 410 may provide an input box 430 such that a user may input any predefined value for the simulated altitude.

FIG. 4C depicts another embodiment after one of the type of plants in FIG. 4A is selected. Referring to FIGS. 1, 3, and 4C, the graphical user interface 410 shows plant A being selected, and one or more simulated geographical regions 440 for selecting where plant A is grown. The options may include different simulated geographical regions, such as Regions A, B, C, and D. The user may select one of the simulated geographical regions for growing plant A. If Region A is selected, the display 104 and/or user computing device 352 transmits the selection of Region A to the master controller 206, and the master controller 206 determines a pressure based on the information about Region A. For example, an average air pressure in Region A is pre-stored in the plant logic 336, and the master controller 206 retrieves the average air pressure in Region A from the plant logic 336. By way of another example, a range of air pressures for Region A may be predefined in the plant logic 336. Each of the one or more simulated geographical regions may correspond to an actual region in the world or even be labeled as such in the graphical user interface 410. For example, the one or more simulated geographical regions may include, for example, Napa Valley American Viticultural Area (AVA), North American Plains, mid-Atlantic US Seaboard, Northwest Europe, or uplands of Southeast Asia. Each of the simulated geographical regions may include a unique climate for growing a particular type of plant. The unique climate may also have a unique air pressure, which allows the growth of the plant material to thrive. By providing the simulated geographical regions with reference to a particular location in the world, a user may more readily associate the type of plant with the simulated geographical region for selection. For example, Napa Valley AVA may inherently relate to growing grapes or other types of fruit, while the North American Plans may relate to growing wheat, grass, soy beans and the like, and the uplands of Southeast Asia relate to growing rice or other marsh/upland type plants.

In some embodiments, the pressure recipe may be defined based on a season of the year in a particular geographical region of the world. For example, the pressure recipe may include the range of air pressures present during the spring and summer seasons (or other growing seasons) of the North American Plains. By way of another example, the pressure recipe may include the range of air pressures present during the rainy season of Southeast Asia.

In some embodiments, the master controller 206 may then store the selected type of plant and the selected simulated geographical region as a pressure recipe in the one or more non-transitory, processor-readable storage mediums 334 and/or the data storage device 337. While in some embodiments, the master controller 206 instructs the air pressure controller 310 to set the air pressure of the first sealed area 344 according to the average air pressure in Region A (e.g., the selected simulated geographical region).

In embodiments, the options 420 for selecting simulated altitudes for plants may be updated based on information of harvested plants from the assembly line grow pod 100. For example, if harvested plants A at a simulated altitude of 3,000 feet are less productive compared to harvested plants at simulated altitudes lower than 3,000 feet, the option for selecting 3,000 feet may be removed. As another example, if harvested plants A at a simulated altitude of 1,000 feet are in better quality than harvested plants A at different simulated altitudes, more simulated altitude options close to 1,000 feet may be added. For example, the options 420 in FIG. 4B may be changed to 960 feet, 980 feet, 1,000 feet and 1,020 feet. As another example, if harvested plants A at Region D are less productive compared to harvested plants at different simulated geographical regions, the option for selecting Region D may be removed.

In some embodiments, a pressure recipe may include a type of plant and one air pressure for growing. However, to simulate and provide optimal growing conditions for the plant material within the assembly line grow pod 100, the pressure recipe may define a regime of a first, second, third, or more air pressures to cycle through. For example, a pressure recipe for Region A may include a first air pressure for a first duration of time and then adjusting the air pressure within the enclosure 102 to a second air pressure for a second duration of time. A changing or oscillating air pressure may better simulate a real climate and provide an optimal growing condition for the plant material growing within the assembly line grow pod 100. That is, air pressure may affect plant growth parameters, transpiration, and even CO₂ gas exchange. Additionally, air pressure directly affects not only cells and organelles in leaves but also the diffusion coefficients and degrees of solubility of CO₂ and O₂.

For example, the pressure recipes for several example plants A, B, and C are shown in Table 1 below.

| Plant Type | Pressure Recipe |
|---|---|
| Plant A | 95.5 kPa |
| Plant B | 95.5 kPa to 97.7 kPa cycling every 4 hours |
| Plant C | 95.5 kPa 1 hour prior to watering and hold for 1 hour after |
| | watering |
| | 102.5 kPa during all other periods |

As depicted in the example pressure recipe in Table 1, in some embodiments, the air pressure is associated with another condition for growing the plant material in the assembly line grow pod 100. For example, the air pressure may be decreased when the plants are watered to simulate typical environmental conditions such as a pressure drop when it rains. Similarly, during periods of sunlight or light provided by the one or more lighting devices 216, the air pressure may be increased to simulate a high-pressure clear and sunny day. Additionally, the increased pressure may assist with photosynthesis or other growth parameters of the plant material.

For example, Plant A includes a pressure recipe that defines a constant air pressure, for example, at 95.5 kPa. The pressure recipe for Plant B includes a range of air pressure, which may be cycled from minimum to maximum over four hours and then maximum to minimum during the next four hours, (i.e., defining a ramp time of four hours). The pressure recipe for Plant C associates the air pressure level to other grow parameters. For example, for 1 hour before and after watering the air pressure is to be maintained at a lower air pressure, for example, 95.5 kPa. During all other periods of growing, the air pressure may be maintained at a higher air pressure, for example, 102.5 kPa, during lighting cycles. It should be understood that these are only a few examples and combinations for a pressure recipe. Other pressure recipes are also considered to be within the scope of the present disclosure.

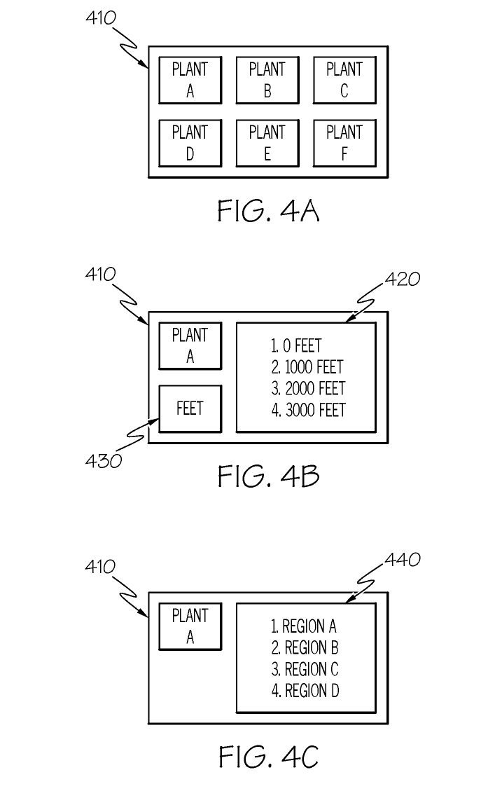

FIG. 5 depicts a flow chart for a general method of controlling the air pressure of the first sealed area 344 based on a pressure recipe. Referring to FIGS. 1, 3, and 5, the master controller 206 identifies the plant material being grown in the assembly line grow pod 100 at block 510. The master controller 206 may identify the plants through a variety of means. For example, a user may input the type of plant material (e.g., the type of seeds for plants) that is or will be grown in the assembly line grow pod 100. The user may input this information through the user computing device 352 and/or an input device 105, for example that is communicatively coupled to the display 104. As such, the master controller 206 may receive the type of plant material (e.g., the types of seeds or plants) from the user computing device 352 and/or an input through an input device 105, for example, communicatively coupled with the display 104. As another example, the master controller 206 may obtain identification of plants from the seeder component 208 that seeds the plants. In yet another non-limiting example, the master controller 206 may identify the plant based on an image or other sensor data provided from one or more sensors within the assembly line grow pod 100.

At block 520, the master controller 206 obtains a pressure recipe based on the identified plant material that is grown in the assembly line grow pod 100. For example, the master controller 206 obtains a pressure recipe for mushrooms if the plant material that is grown in the assembly line grow pod 100 are mushrooms that are grown in a simulated altitude of 3,000 feet in nature. The pressure recipe may include a pressure that is comparable to a pressure at an altitude of 3,000 feet. In embodiments, the pressure recipe may be pre-stored in the data storage device 337, which may be accessed by the master controller 206 and/or the processor 338. In some embodiments, a user may input the pressure recipe to the master controller 206 through the display 104, user computing device 352, and/or the remote computing device 354. In some embodiments, the master controller 206 may retrieve the pressure recipe for the plant material from the remote computing device 354.

At block 530, the master controller 206 instructs the air pressure controller 310 to control the air pressure of the first sealed area 344 according to the pressure recipe (i.e., control the air pressure to be equal to the pressure of the pressure recipe). For example, if the pressure of the pressure recipe for plant A is 90.8 kPa and the pressure of the first sealed area 344 is 99.5 kPa, the master controller 206 instructs the air pressure controller 310 to lower the air pressure of the first sealed area 344 to be 90.8 kPa before or after seeding plant A. In this regard, the assembly line grow pod 100 simulates environment at an altitude appropriate for corresponding plants to grow without any need to move the assembly line grow pod 100 to locations at different altitudes. In some embodiments, the pressure recipe may be changed based on the stage of development of the plant material, and/or the conditions of the plant material. For example, the pressure of the pressure recipe in the stage of early development of the plant material may be set smaller than the pressure of the pressure recipe in the stage of late development of the plant material.

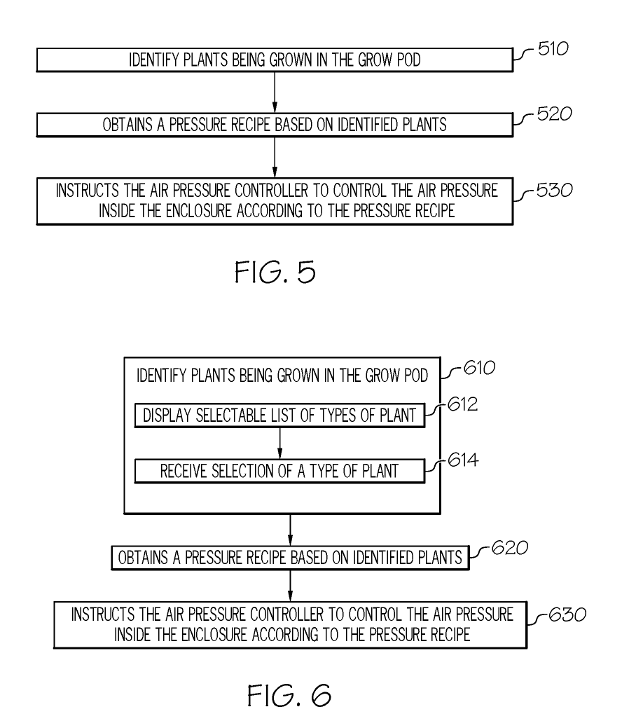

Referring now to FIG. 6, an alternate method for controlling the air pressure of the first sealed area 344 based on a pressure recipe is depicted. Referring to FIGS. 1, 3, and 6, the master controller 206 identifies plants being grown in the assembly line grow pod 100 at block 610. The master controller 206 may identify the plants through a variety of means. For example, at block 612, the master controller may cause a display 104 to present a selectable list of types of plants (e.g., plant material). The display 104 may include or be coupled to an input device 105. At block 614, the master controller 206 may receive a selection of one of the types of plant material presented in the selectable list.

Once the master controller 206 has identified the type of plant material being grown in the assembly line grow pod 100, at block 620, the master controller 206 obtains a pressure recipe based on the identified plant material that is grown in the assembly line grow pod 100. For example, the master controller 206 may retrieve the pressure recipe corresponding to the selected plant from a data storage device 337. The data storage device 337 may be within the master controller 206 or communicatively coupled thereto. In some embodiments, the master controller 206 may retrieve the pressure recipe for the plant material from the remote computing device 354.

At block 630, the master controller 206 instructs the air pressure controller 310 to control the air pressure of the first sealed area 344 according to the pressure recipe (i.e., control the air pressure to be equal to the pressure of the pressure recipe). In some embodiments, the master controller 206 instructs the air pressure controller 310 to increase the air pressure within the first sealed area 344 by pumping air into the first sealed area 344. In some embodiments, the master controller 206 instructs the air pressure controller 310 to decrease the air pressure within the first sealed area 344 by releasing air from the first sealed area 344.

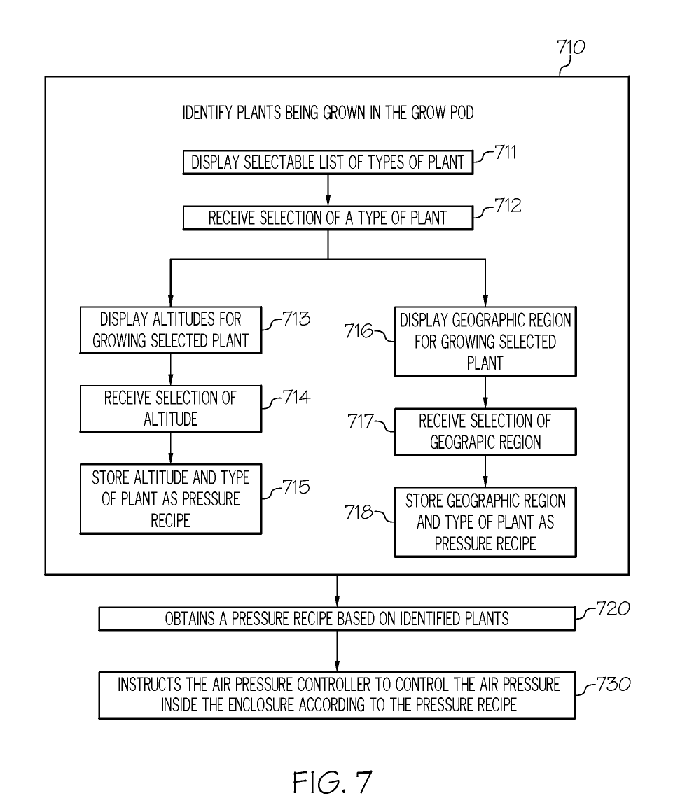

In some embodiments, a user may define a pressure recipe for a type of plant material growing in the assembly line grow pod. For example, referring to FIG. 7, a flow chart for a method of identifying, retrieving, defining, and implementing a pressure recipe is depicted. At block 710, a method of identifying plant material being grown within the assembly line grow pod is shown. At block 711, the master controller 206 may cause a display 104 to present a selectable list of types of plant material. The display 104 may include or be coupled to an input device 105. At block 712, the master controller 206 may receive a selection of one of the types of plant material presented in the selectable list. Once a type of plant material is selected, one of a variety of means to define the pressure recipe for the type of plant material may be used. For example, the pressure recipe may be defined with respect to a simulated altitude range for growing the plant material, a simulated geographical region for growing the plant material, a specific air pressure range or the like. The flow chart in FIG. 7 includes two illustrative examples for identifying the plant material and defining the pressure recipe. For example, one method includes using a simulated altitude range and another method includes using a simulated geographical region. At block 713, a set of simulated altitude ranges for growing the selected plant material may be presented on a display 104. The simulated altitude ranges may include specific ranges or an option to enter a predefined value. At block 714, the master controller 206 may receive a selection of a simulated altitude range. Then, the master controller 206, at block 715, may store the selected plant material and the selected simulated altitude range in the data storage device 337 as a pressure recipe.

By way of another example, at block 716, a set of simulated geographical regions for growing the selected plant material may be presented on a display. The simulated geographical regions may include specific regions around the world that correspond to locations for growing the type of plant material. At block 717, the master controller 206 may receive a selection of a simulated geographical region. Then, the master controller, at block 718, may store the selected plant material and the selected simulated geographical region in the data storage device 337 as a pressure recipe. However, it should be understood that the methods depicted in blocks 713-715 and blocks 716-718 are merely illustrative examples, and other means of identification are also included without departing from the scope.

Once the master controller 206 has identified the type of plant material and the pressure recipe for the type of plant material being grown in the assembly line grow pod 100, at block 720, the master controller 206 obtains a pressure recipe based on the identified plant material that is grown in the assembly line grow pod 100. For example, the master controller 206 may retrieve the pressure recipe corresponding to the selected plant from a data storage device 337. The data storage device 337 may be within the master controller 206 or communicatively coupled thereto. In some embodiments, the master controller 206 may retrieve the pressure recipe for the plant material from the remote computing device 354.

At block 730, the master controller 206 instructs the air pressure controller 310 to control the air pressure of the first sealed area 344 according to the pressure recipe (i.e., control the air pressure to be equal to the pressure of the pressure recipe). In some embodiments, the master controller 206 may receive one or more signals from one or more air pressure gauges 314 connected to the first sealed area 344. The one or more signals may correspond to the air pressure within the first sealed area 344. The master controller 206 may compare the air pressure within the first sealed area 344 with the predefined air pressure in the pressure recipe. If the air pressure within the first sealed area is less than the predefined air pressure, the master controller 206 may cause the air pressure controller 310 to pump air into the first sealed area 344. However, if the air pressure within the first sealed area is greater than the predefined air pressure, the master controller 206 may cause the air pressure controller 310 to release air from the first sealed area 344.

It should be understood that FIGS. 5-7 depict only a few examples of implementing control of the pressure within the environment of an assembly line grow pod by utilizing a pressure recipe. That is, other means of implementing control of the pressure within the environment of the assembly line grow pod utilizing a pressure recipe are also contemplated.

As illustrated above, various embodiments for utilizing pressure recipes for a grow pod are disclosed. These embodiments create a quick growing, small footprint, chemical free, low labor solution to growing microgreens and other plants for harvesting. These embodiments may create recipes and/or receive recipes that dictate the air pressure that optimize plant growth and output. The recipe may be implemented strictly and/or modified based on results of a particular plant, tray, or crop.

Accordingly, some embodiments may include a pressure control system that includes an exterior enclosure for enclosing a grow pod, an air pressure controller, and a master controller, wherein the exterior enclosure includes an outer wall and an inner wall; and the master controller identifies plants being grown in the grow pod, and instructs the air pressure controller to control an air pressure of a sealed area inside the inner wall based on a pressure recipe for the plants.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein includes systems, methods, and non-transitory computer-readable mediums for utilizing pressure recipes for a grow pod. It should also be understood that these embodiments are merely exemplary and are not intended to limit the scope of this disclosure.

What is claimed is:

1. A pressure control system comprising:
a sealed area containing one or more carts for growing plant material, the one or more carts movably supported on a track within the sealed area;
an air pressure controller operably coupled to the sealed area such that the air pressure controller controls an air pressure within the sealed area; and
a controller comprising:
a processor;
a data storage device storing one or more pressure recipes; and
a non-transitory, processor-readable storage medium comprising one or more programming instructions stored thereon that, when executed by the processor, cause the processor to:
identify the plant material in the one or more carts;
retrieve a pressure recipe for the identified plant material from the data storage device; and
direct the air pressure controller to adjust the air pressure within the sealed area based on the pressure recipe for the identified plant material.

2. The pressure control system of claim 1, further comprising a second sealed area enclosing the sealed area, wherein the air pressure controller further controls the air pressure within the sealed area and the one or more programming instructions, when executed by the processor, further cause the processor to direct the air pressure controller to maintain a positive pressure in the second sealed area relative to an environment external to the second sealed area.

3. The pressure control system of claim 1, further comprising a display having an input device, wherein the one or more programming instructions, when executed by the processor, further cause the processor to identify the plant material in the one or more carts by:
causing the display to present a selectable list of one or more types of plant material; and
receiving a selection, via the input device, of one of the one or more types of plant material.

4. The pressure control system of claim 3, wherein the one or more programming instructions, when executed by the processor, further cause the processor to:
cause the display to present one or more simulated altitude ranges for growing the selected one of the one or more types of plant material, wherein each of the one or more simulated altitude ranges corresponds to a predefined air pressure;
receive a selection, via the input device, of one of the one or more simulated altitude ranges; and
direct the data storage device to store the selected one of the one or more simulated altitude ranges and the selected one of the one or more types of plant material as the pressure recipe for the selected one of the one or more types of plant material.

5. The pressure control system of claim 3, wherein the one or more programming instructions, when executed by the processor, cause the processor to:
cause the display to present one or more simulated geographical regions for growing the selected one or the one or more types of plant material, wherein each of the one or more simulated geographical regions correspond to one or more predetermined air pressures;
receive, via the input device, a selection of one of the one or more simulated geographical regions; and
direct the data storage device to store the selected one of the one or more simulated geographical regions and the selected one of the one or more types of plant material as the pressure recipe for the selected one of the one or more types of plant material.

6. The pressure control system of claim 1, wherein the pressure recipe defines a first air pressure for a first duration of time and a second air pressure for a second duration of time, and wherein the first air pressure is not equal to the second air pressure.

7. The pressure control system of claim 1, wherein the air pressure controller comprises at least one of an air pressure decreasing device or an air pressure increasing device, wherein the air pressure decreasing device decreases the air pressure within the sealed area and the air pressure increasing device increases the air pressure within the sealed area.

8. A method for controlling an air pressure within an assembly line grow pod, the method comprising:
identifying, by a grow pod computing device, plant material in one or more carts, wherein the one or more carts are disposed in a sealed area of the assembly line grow pod, the sealed area having the air pressure controlled by an air pressure controller;
retrieving, by the grow pod computing device, a pressure recipe corresponding to the identified plant material from a data storage device; and
directing, by the grow pod computing device, the air pressure controller to adjust the air pressure within the sealed area based on the pressure recipe for the identified plant material.

9. The method of claim 8, further comprising:
determining the air pressure within the sealed area;
comparing the air pressure to a predefined pressure in the pressure recipe;
directing the air pressure controller to pump air into the sealed area when the air pressure within the sealed area is less than the predefined pressure; and
directing the air pressure controller to decrease the air pressure within the sealed area when the air pressure within the sealed area is greater than the predefined pressure.

10. The method of claim 8, wherein identifying the plant material in the one or more carts comprises:
causing a display communicatively coupled to an input device to present a selectable list of one or more types of plant material; and
receiving, via the input device, a selection of one of the one or more types of plant material.

11. The method of claim 10, further comprising:
causing the display to present one or more simulated altitudes for growing the selected one or the one or more types of plant material, wherein each of the one or more simulated altitudes correspond to a predefined air pressure;
receiving, via the input device, a selection of one of the one or more simulated altitudes; and
directing the data storage device to store the selected one of the one or more simulated altitudes and the selected one of the one or more types of plant material as the pressure recipe for the selected one of the one or more types of plant material.

12. The method of claim 10, further comprising:
causing the display to present one or more simulated geographical regions for growing the selected one or the one or more types of plant material, wherein each of the one or more simulated geographical regions correspond to one or more air pressures;
receiving, via the input device a selection of one of the one or more simulated geographical regions; and
directing the data storage device to store the selected one of the one or more simulated geographical regions and the selected one of the one or more types of plant material as the pressure recipe for the selected one of the one or more types of plant material.

13. The method of claim 8, further comprising directing the air pressure controller to maintain a second air pressure in a second sealed area that encompasses the sealed area such that the second air pressure is a positive pressure with respect to an environment external to the second sealed area.

14. The method of claim 8, wherein directing the air pressure controller to adjust the air pressure within the sealed area based on the pressure recipe comprises directing the air pressure controller to adjust the air pressure within the sealed area to a first air pressure for a first duration of time and a second air pressure for a second duration of time, wherein the first air pressure is not equal to the second air pressure.

15. An assembly line grow pod comprising:
an enclosure comprising:
an inner wall,
an outer wall encompassing the inner wall,
a first sealed area defined within the inner wall, and
a second sealed area defined between the inner wall and the outer wall,
a cart supported on a track within the first sealed area,
an air pressure controller fluidly coupled to the first sealed area and the second sealed area, and
a controller communicatively coupled to the air pressure controller, the controller providing signals to the air pressure controller to adjust an air pressure within the first sealed area and the second sealed area.

16. The assembly line grow pod of claim 15, wherein the air pressure controller fluidly couples to an external environment outside the outer wall.

17. The assembly line grow pod of claim 15, wherein the controller comprises:
a processor;
a data storage device storing one or more pressure recipes; and
a non-transitory, processor-readable storage medium comprising one or more programming instructions stored thereon that, when executed by the processor, cause the processor to:
identify a plant material in the cart;
retrieve a pressure recipe for the identified plant material from the data storage device; and
direct the air pressure controller to adjust the air pressure within the first sealed area based on the pressure recipe for the identified plant material.

18. The assembly line grow pod of claim 17, further comprising:
a display and an input device communicatively coupled to the controller, wherein the one or more programming instructions, when executed, further cause the processor to:
cause the display to present one or more simulated altitude ranges for growing the identified plant material, wherein each of the one or more simulated altitude ranges corresponds to a predetermined air pressure;
receive, via the input device, a selection of one of the one or more simulated altitude ranges; and
direct the data storage device to store the selected one of the one or more simulated altitude ranges and the identified plant material as the pressure recipe for the identified plant material.

19. The assembly line grow pod of claim 17, further comprising:
a display and an input device communicatively coupled to the controller, wherein the one or more programming instructions, when executed, further cause the processor to:
cause the display to present one or more simulated geographical regions for growing the identified plant material, wherein each of the one or more simulated geographical regions correspond to a predetermined air pressure;
receive, via the input device, a selection of one of the one or more simulated geographical regions; and
direct the data storage device to store the selected one of the one or more simulated geographical regions and the identified plant material as the pressure recipe for the identified plant material.

20. The assembly line grow pod of claim 15, wherein the controller causes the air pressure controller to maintain a positive pressure within the second sealed area with respect to an external environment outside the outer wall.
